(19) United States
(12) Patent Application Publication
(10) Pub. No.: US 2003/0207673 A1
(43) Pub. Date: Nov. 6, 2003

(54) Constant-current source circuit, intermediate-frequency gain control circuit and mobile terminal device

(76) Inventor: Syuuichi Takayoshi, Kagoshima (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/860,497

(22) Filed: May 21, 2001

(30) Foreign Application Priority Data
May 23, 2000 (JP) P2000-151631

(51) Int. Cl. H04B 1/06; H04B 7/00

(52) U.S. Cl. 455/232.1

(57) ABSTRACT

In order to provide a constant current source circuit which is capable of covering variety of specifications in a single circuit, there is provided a constant-current source circuit provided having a desired temperature characteristic with a current regulation being set at a predetermined value, in which a first current unit generates a first constant current based on a first resistor connected between a pin and the ground; a second current unit generates a second constant current based on a second resistor connected between a pin and the ground; an adder adds the first and second constant currents; a current amplifying unit generates a third constant current by adding the constant-currents and then multiplying n-fold to inflow or outflow the third constant current via the pin; a current regulation of the third constant current is set at a predetermined value by determining the resistances of the first and second resistors.

### CROSS REFERENCES TO RELATED APPLICATIONS

The present invention claims priority from priority document, Japanese Patent Application No. 2000-151631 filed with the Japanese Patent Office on May 23, 2000, and the disclosure of which is expressly incorporated by reference herein.

### BACKGROUND OF THE INVENTION

1. Technical Field of the Invention

The present invention relates to a constant-current source circuit, intermediate-frequency gain control circuit and mobile terminal device, and more specifically to a constant-current source circuit capable of arbitrarily setting a current regulation, namely, a temperature characteristic of an output current, an intermediate-frequency gain control circuit in which the constant-current source circuit is employed and a mobile terminal device having the intermediate-frequency gain control circuit at a front-end portion thereof.

2. Description of the Related Art

A circuit mounted on a mobile terminal device such as a portable telephone is required to be small-scale, since the device itself is compact, and functional to endure various environments for usage. The circuit within the device has parts utilizing a constant-current source. Therefore, there was a need for a set design engineer to mount the constant-current source circuit having the predetermined temperature characteristic in consideration of relationships between peripheral circuits and the parts.

In the constant-current source circuit, when it is designed to have a large set current value of the output current, the current regulation becomes large, and when it is designed to have the small current regulation, the set current value becomes small. That is, the set current value is proportional to the current regulation. Herein, the current regulation is expressed as (I−I0)/(T−T0), when a reference temperature is T0, the current value thereat is I0, and the current value is I at the time the temperature has changed to T. In other words, the current regulation is a ratio of variation of an output current against variation in temperature. The current regulation of the output current is regarded as an indicator for the temperature characteristic of the constant-current source circuit.

Conventionally, in a constant-current source circuit, a construction, in which respective current sources in conformity with each specification such as an output current having a large variation in temperature characteristics or an output current having a small variation in temperature characteristics is covered by respective circuits, has been employed. That is, no constant-current source circuit for general-purpose utilization has been provided conventionally.

However, in a conventional technique in which the above-mentioned construction in which a current source in conformity with a corresponding specification is covered by a corresponding circuit is employed, further circuits are required when the specification varies. Accordingly, the set design engineer who is in charge of designing of product set such as a mobile terminal device and the like is required to select an IC (Integrated Circuit) having the constant-current source circuit with the desired temperature characteristic, which has caused problems of providing the heavier burden on working out the design.

### SUMMARY OF THE INVENTION

The present invention has been made to solve the problems caused by the above-described conventional technique, and its object is to provide a constant-current source circuit capable of setting a desired temperature characteristic at a desired value arbitrarily in a single circuit, an intermediate frequency (IF) gain control circuit in which the constant-current source circuit is employed and a mobile terminal device to which the constant-current source circuit is applied.

The constant-current source circuit according to the present invention comprises: a plurality of current sources each having a circuit so that current regulations thereof vary each other; output means for adding and outputting output currents from the plurality of current source; and setting means for setting addition ratio of the output currents at the output means. Such a constant-current source circuit is employed in an intermediate-frequency (IF) gain control circuit which constitutes a front-end portion of a mobile terminal device such as a digital cellular terminal and the like.

In the constant-current source circuit having the above-described structure, it is possible to adjust the current regulation freely by adding respective output currents of the plurality of current source, each of which has current regulation different from each other and setting the addition ratio thereof arbitrarily. Accordingly, it is possible to provide with ease a constant-current source circuit having a desired temperature characteristic with a single circuit.

Other and further objects, features and advantages of the present invention will appear more fully from the following description.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a block diagram of an intermediate-frequency gain control circuit wherein a constant-current source circuit of one embodiment of the present invention is mounted;

FIG. 2 is a block diagram showing a structural example of a constant-current source circuit according to one embodiment of the present invention;

FIG. 3 is a circuit diagram showing a concrete example of a first current unit;

FIG. 4 is a circuit diagram showing a concrete example of a second current unit;

FIG. 5 is a circuit diagram showing a concrete example of a current amplifier (amplifying unit);

FIG. 6 shows a temperature characteristic of respective current regulation of constant-currents I1 and I2 against set current value I0; and

FIG. 7 is a block diagram showing an example of a structure of an RF front-end portion in a CDMA-type digital cellular terminal.

### DESCRIPTION OF THE PREFERRED EMBODIMENTS

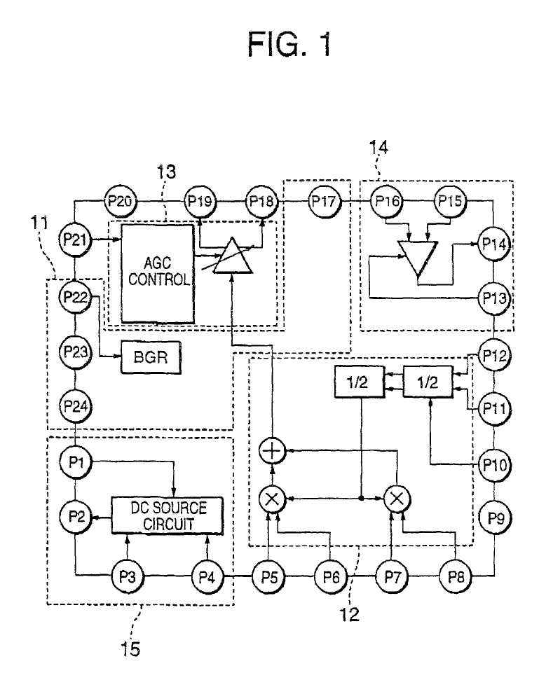

Hereunder, according to embodiments of the present invention, there is described a constant-current source circuit in detail by referring to the attached drawings. FIG. 1 is a block diagram of an intermediate-frequency gain control circuit in which the constant-current source circuit of one embodiment of the present invention is mounted. In FIG. 1, the intermediate-frequency gain control circuit is an IC configured with 24 pins, from P1 to P24 (hereinafter, referred to as “intermediate-frequency gain control IC), for example, and comprised of a reference-voltage generating unit 11, a quadrature modulating unit 12, a variable amplifying unit 13, a control voltage buffer unit 14 and a constant-current generating unit 15..

The reference-voltage generating unit 11 is provided for generating a variety of reference voltages utilized inside the IC, and is comprised of a BGR (band gap reference) which generates a constant voltage without being affected by temperature change or source voltage variation. The quadrature modulating unit 12 receives a modulated signal from an external D/A (digital/analog) converting unit (not shown) through the pins P5-P8 and a carrier signal through the pins P11 and P12. The quadrature modulating unit 12 performs quadrature modulation of the modulated signal with the carrier signal and inputs a quadrature modulated signal to the variable amplifying unit 13. The variable amplifying unit 13 amplifies the quadrature modulated signal input from the quadrature modulating unit 12 in accordance with an AGC (automatic gain control) voltage input from an external control unit (not shown) through the pin P21, and outputs the amplified signal to an external high-frequency signal processing unit (not shown) through the pins P18 and P19. The control voltage buffer unit 14 takes in control current through the pins P15 and P16 and outputs the control current as a control voltage to outside through the pin P14.

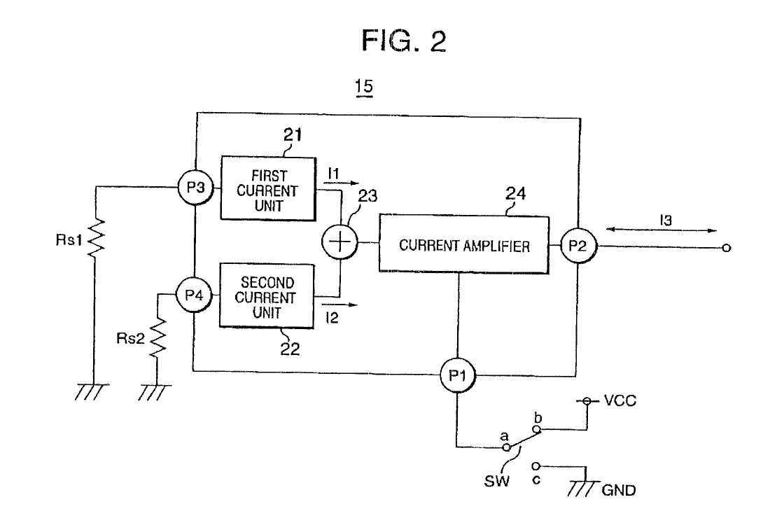

The constant-current generating unit 15 is the constant-current source circuit according to the present invention, and supplies a constant current having a predetermined temperature characteristic to various external circuits (not shown) outside the intermediate-frequency gain control IC. The constant-current generating unit 15 is mounted in the intermediate-frequency gain control IC as an additional circuit provided for an object other than a function intrinsic to an intermediate-frequency gain control IC. Outside the intermediate-frequency gain control IC, there exist a variety of circuits requiring a constant current, as external circuits, and the constant current generated in the constant-current generating unit 15 is supplied to these external circuits. FIG. 2 is a block diagram showing a structural example of the constant-current generating unit 15, that is the constant-current source circuit according to the present embodiment.

As is apparent from FIG. 2, the constant-current generating unit 15 is comprised of an inner circuit including a first current unit 21, a second current unit 22, and an adder 23 and a current amplifying unit 24, and an external circuit including resistors Rs1 and Rs2 and a switch SW. The first current unit 21, the second current unit 22, the adder 23 and the current amplifier (amplifying unit) 24 of the inner circuit are disposed on one substrate. The pins P1 to P4 of the intermediate-frequency gain control IC of FIG. 1 are assigned to the constant-current generating unit 15.

An input terminal the first current unit 21 is connected to the pin P3 and an output terminal of the first current unit 21 is connected to one of input terminals of the adder 23. The resistor Rs1 is connected between the pin P3 and the ground. Accordingly, the first current unit 21 outputs a constant current I1 whose current value is determined in accordance with a resistor value of the resistor Rs1. The second current unit 22 is configured with an input terminal being connected to the pin P4 and an output terminal being connected to the other of the input terminals of the adder 23. The resistor Rs2 is connected between the pin P4 and the ground. Accordingly, the second current unit 22 outputs a constant current I2 whose current value is determined in accordance with a resistor value of the resistor Rs2.

The adder 23 adds the constant current I1 output from the first current unit 21 and the constant current I2 output from the second current unit 22. The ratio of the addition herein is determined in accordance with a ratio between the current value of the constant current I1 and the current value of the constant current I2. Each of the current values of the constant currents I1 and I2 are determined in accordance with each of the resistor values of the resistors Rs1 and Rs2, respectively. In other words, the ratio of the addition of the constant current I1 and the constant current I2 in the adder 23 is set in accordance with the resistors Rs1 and Rs2.

In the current amplifying unit 24, an input terminal of the current amplifying unit 24 is connected to an output terminal of the adder 23, an output terminal is connected to the pin P2 and a control input terminal is connected to the pin P1. A movable terminal “a” of the switch SW is connected to the pin P1. One of fixed terminals “b” of the switch SW is connected to the power source (VCC) line, and the other of the fixed terminals “c” is connected to the ground (GND), respectively.

The current amplifying unit 24 has an amplifying degree “n”, and amplifies the added constant currents (I1+I2) added by the adder 23 by multiplying it n-fold or −n-fold in accordance with an electric potential level of the pin P1 to generate and output a constant current I3. For example, in a case where the switch SW is connected to the terminal “b” and the electric potential level of the pin P1 is the VCC level, an n-folded constant current I3 outflows through the pin P2, and in a case where the switch SW is connected to the terminal “c” and the electric potential level of the pin P1 is the ground level, a reverse polarity. −n-folded constant current I3 inflows through the pin P2.

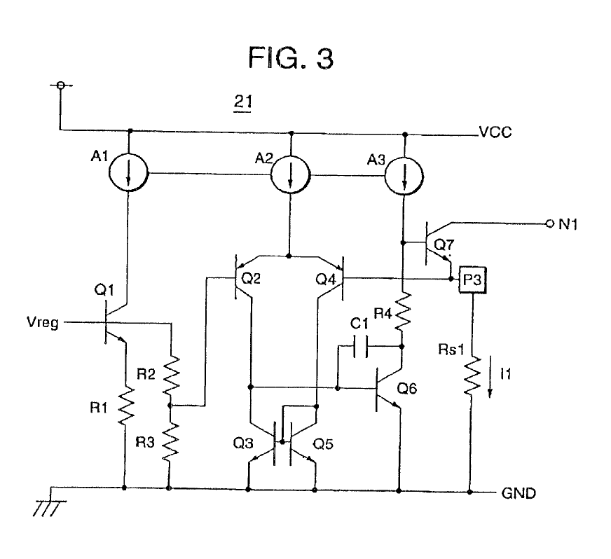

FIG. 3 is a circuit diagram showing a concrete example of the first current unit 21 referring to FIG. 2. The first current unit 21 is comprised of current sources A1 to A3, PNP transistors Q2, Q4, NPN transistors Q1, Q3, Q5 to Q7, resistors R1 to R4, and a capacitor C1, as in apparent from FIG. 3.

Inflow terminals of the current sources A1 to A3 are all connected to the source voltage VCC. These current sources A1 to A3 operate in conjunction with one another, respectively, and constitute a current mirror which generates a current of a predetermined ratio. As to the transistor Q1, a collector is connected to the outflow terminals of the current source A1, and an emitter is connected to the ground via the resistor R1. A reference voltage Vreg is applied to a base of the transistor Q1. The reference voltage Vreg is one of the reference voltages generated at the reference-voltage generating unit 11 of FIG. 1, and its current regulation is not affected by temperature.

The emitters of the transistors Q2 and Q4 are both connected to the outflow terminals of the current source A2. The emitters of the transistors Q3, Q5, and Q6 are all connected to the ground. The reference voltage Vreg is applied to a base of the transistor Q2 via the resistor R2. As to the transistor Q2, the base is connected to the ground via the resistor R3 and a collector is connected to a collector of the transistor Q3 and to a base of the transistor Q6, respectively. As to the transistor Q4, a base is connected to an emitter of the transistor Q7 and to the pin P3, and a collector is connected to a collector of the transistor Q5.

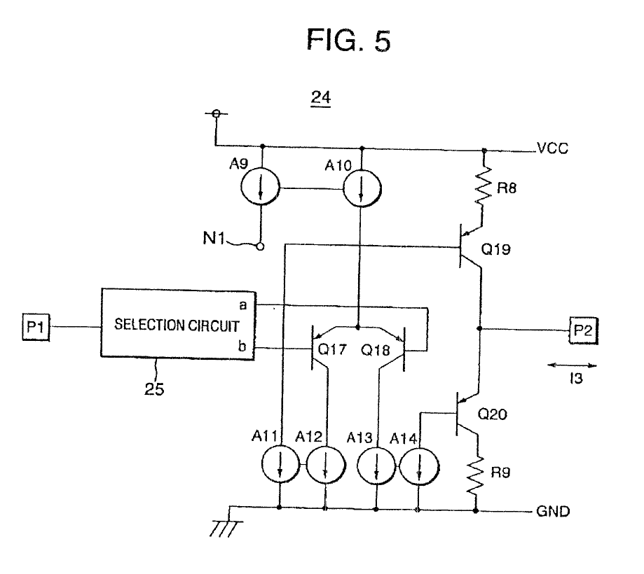

Bases of the transistors Q3 and Q5 are commonly connected and the base and the collector of the transistor Q5 are commonly connected. As to the transistor Q6, the base is connected to the collector via the capacitor C1, and the collector is connected to the outflow terminal of the current source A3 via the resistor R4. and to the base of the transistor Q7, respectively. The collector of the transistor Q7 is connected to a node N1 (see FIG. 5) of the current amplifying unit 24.

Herein, an open voltage of the pin P3 is V1. Assuming that the resistor value of the resistor Rs1 connected between the pin P3 and the ground is Rs1, the constant current I1 having a current value which satisfies an equation I1=V1/Rs1 flows from the node N1 to the collector of the transistor Q7. That is, the current value of the constant current I1 is determined in accordance with the resistor value of the resistor Rs1.

In the first current unit 21 having the above-described construction, the reference voltage Vreg having no current regulation due to temperature change is applied to the base of the transistor Q2 via the resistor 2, and received by the pin P3 via the transistors Q2 and Q4. According to such a circuit construction, since the temperature drift portions of the transistors Q2 and Q4 offset each other, the current regulation of the constant current I1 becomes zero. In other words, the first current unit 21 is configured to have a current regulation being substantially zero.

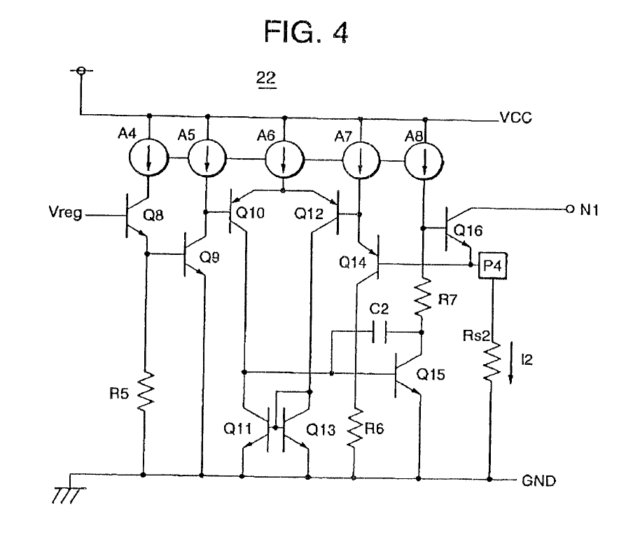

FIG. 4 is a circuit diagram showing a concrete example of the second current unit 22 referring to FIG. 2. The second current unit 22 is comprised of current sources A4 to A8, PNP transistors Q9, Q10, Q12, and Q14, NPN transistors Q8, Q11, Q13, Q15, and Q16, resistors R5 to R7, and a capacitor C2.

The inflow terminals of the current sources A4 to A8 are all connected to the VCC line. These current sources A4 to A8 operate in conjunction with one another, respectively, and constitute a current mirror which generates a current of a predetermined ratio. As to the transistor Q8, the collector is connected to the outflow terminal of the current source A4, and the emitter is connected to the ground via the resistor R5. The reference voltage Vreg which is the same as in the case of the first current unit 21 is applied to the base of the transistor Q8.

As to the transistor Q9, the emitter is connected to an outflow terminal of the current source A5 and to the base of the transistor Q10, the base is connected to the emitter of the transistor Q8, and the collector is connected to the ground. The emitters of the transistors Q10 and Q12 are commonly connected to the outflow terminal of the current source A6. The collector of the transistor Q10 is connected to the collector of the transistor Q11 and the base of the transistor Q15.

The emitters of the transistors Q11, Q13, and Q15 are all connected to the ground. The bases of the transistors Q11 and Q13 are commonly connected, and the collector and the base of the transistor Q13 are commonly connected. The collector of the transistor Q12 is connected to the collector of the transistor Q13 and the base of the transistor Q12 is connected to an outflow terminal of the current source A7 and the emitter of the transistor Q14.

As to the transistor Q14, the collector is connected to the ground via the resistor R6, and the base is connected to the emitter of the transistor Q16 and to the pin P4. The collector of the transistor Q15 is connected to the base via the capacitor C2 and to the outflow terminal of the current source A8 via the resistor R7 as well as to the base of the transistor Q16. The collector of the transistor Q16 is connected to the node N1 of the current amplifying unit 24 (see FIG. 5).

Herein, the open voltage of the pin P4 is V2. Assuming that the resistor value of the resistor Rs2 connected between the pin P4 and the ground is Rs2, the constant current I2 having a current value which satisfies an equation I2=V2/Rs2 flows from the node N1 to the collector of the transistor Q16. That is, the current value of the constant current I2 is determined in accordance with the resistor value of the resistor Rs2.

In the second current unit 22 having the above-described construction, the reference voltage Vreg having no current regulation due to temperature change is applied to the base of the transistor Q9 via the transistor Q8 of an emitter follower, and received by the pin P4 via the transistors Q9, Q10, Q12 and Q14. According to such a circuit construction, since the temperature drift portions of the transistors Q9 and Q14, and the transistors Q10 and Q12 offset each other, there still remains the temperature drift portion of the transistor Q8.

The constant current I2, which is generated according to the reference voltage Vreg, has the current regulation according to the temperature drift portion. In other words, the second current unit 22 is configured to have a current regulation being a predetermined value. In the present example, the current regulation is determined in accordance with the number of transistors corresponding to the transistor Q8.

FIG. 5 is a circuit diagram showing a concrete example of the current amplifying unit 24 referring to FIG. 2. The current amplifying unit 24 of the present embodiment has a circuit configuration also having the function of the adder 23 shown in FIG. 2. The current amplifying unit 24 is comprised of current sources A9 to A14, PNP transistors Q17 to Q20, resistors R8, R9, and a selection circuit 25.

The inflow terminals of the current sources A9 and A10 are all connected to the VCC line. The outflow terminals of the current sources A11 to A14 are all connected to the ground. These current sources A9 and A10, and A11 and A12 operate in conjunction with each other, respectively, and constitute a current mirror which generates a current of a predetermined ratio. As to the selection circuit 25, an input terminal is connected to the pin P1, one of selection output terminals “a” is connected to the base of the transistor Q18, and the other of the selection output terminals “b” is connected to the base of the transistor Q17.

The emitters of the transistors Q17 and Q18 are commonly connected to the outflow terminal of the current source A10. The collector of the transistor Q17 is connected to the inflow terminal of the current source A12. The collector of the transistor Q18 is connected to the inflow terminal of the current source A13. As to the transistor Q19, the emitter is connected to the VCC line via the resistor R8, the base is connected to the inflow terminal of the current source A11, and the collector is connected to the collector of the transistor Q20 and the pin P2.

As to the transistor Q20, the base is connected to the inflow terminal of the current source A14, and the emitter is connected to the ground via the resistor R9. The node N1, which is the outflow terminal of the current source A9, is connected to the collector of the transistor Q7 of the first current unit 21 (See FIG. 3) and the collector of the transistor Q16 of the second current unit 22 (See FIG. 4).

In the current amplifying unit 24 having the above-described structure, in accordance with the electrical potential of the pin P1, that is whether the electrical potential of the pin P1 is the level of the VCC line or the ground, the selection circuit 25 makes either one of the selection output “a” or the selection output “b” to stay at “H” level and the other at “L” level. When the selection output “a” is at “H” level, both the transistor Q17 and Q19 are brought into conduction and both the transistors Q18 and Q20 are interrupted, whereby the constant-current I3 outflows externally via the pin P2. When the selection output “b” is at “H” level, both the transistors Q17 and Q19 are interrupted, and both the transistors Q18 and Q20 are conducted, whereby the constant-current I3 inflows from outside via the pin P2.

Since the current amplifying unit 24 has an amplifying degree in accordance with a setting ratio (mirror ratio) between the currents of the current mirror comprising the current sources A9 and A10, A11 and A12, and A13 and A14, or the gain of the transistors, the current amplifying unit 24.

Each of the current sources of A9 and A10, A11 and A12, and A13 and A14 operates interlocked to configure the current mirror which generates the current having the predetermined ratio. The current amplifier (amplifying unit) 24 has an amplification degree n which is based on the set ratio of each other current of the current mirror and the amplification factor of the transistor, thereby generating the constant-current I3 by multiplying n-fold (or −n-fold) the value of current (I1+I2) obtained by addition at the time of discharging from the first current unit 21 (See FIG. 3) and the second current unit 22 (See FIG. 4) to the node N1.

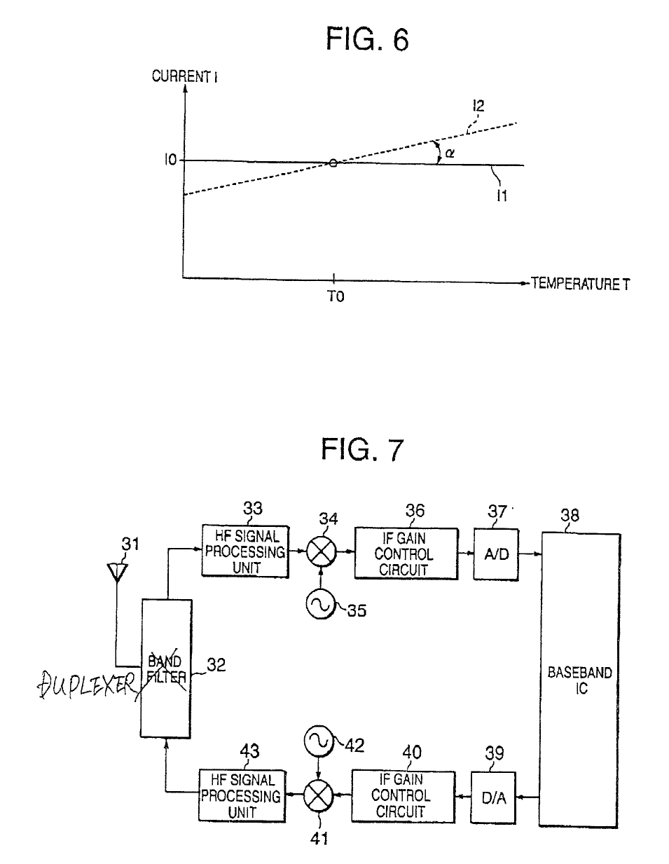

FIG. 6 shows a temperature characteristic of respective current regulation of the constant-currents I1 and I2 against set current value I0. The constant-currents I1 and I2 are set at the set current value I0, when both currents have the temperature T0 (25 degrees), and the current I is measured on the condition of varying the temperature T. The constant-current I1 maintains the set current value I0 without depending on the temperature T. The constant-current I2 varies linearly in proportion to the temperature T.

The constant-current I2 is expressed as the equation (1), when the current regulation is α.

I2=I0×α×[1+{(T−T0)/T0}] (1)

The current regulation α shows the inclination of the constant-current I2 at the temperature T0, as shown in FIG. 6.

When K is the current ratio which is the ratio of the constant-current I2 against the added value of the constant-currents I1 and I2, K is expressed as the equation (2).

K=I2/(I1+I2) (2)

The constant-current I3 is expressed as the equation (3), as the amplification degree of the current amplifier (amplifying unit) 24 is n.

I3=n×(I1+I2)×K×α×[1+[(T−T0)/T0]] (3)

As described above, in the constant-current source circuit (constant-current generating unit 13) according to the present embodiment, the circuit comprises the first current unit 21 which outputs the constant current I1 set in accordance with the resistor Rs1 and is configured to have the current regulation being substantially zero, and the second current unit 22 which outputs the constant current I2 set in accordance with the resistor Rs2 and is configured to have the current regulation being the predetermined value, wherein the constant currents I1 and I2 output therefrom are added at an arbitrary setting ratio determined in accordance with the resistors Rs1 and Rs2 to be outputted as the constant current I3. Thus, it is possible to set a current regulation arbitrarily by selecting the resistor values of the resistors Rs1 and Rs2. Accordingly, it is possible to constitute easily a constant-current source circuit having a desired temperature characteristic in a single circuit.

Incidentally, in the above-described embodiment, fixed resistors are used as the resistors Rs1 and Rs2. Accordingly, fixed resistors having a predetermined resistor value is selected to be used as the resistors Rs1 and Rs2 so as to configure the constant-current source circuit having a desired temperature characteristic. However, it is also possible to use variable resistors as the resistors Rs1 and Rs2. In such a case, it becomes possible to change the setting freely or make a slight adjustment even after the temperature characteristic is once set.

In addition, in the above-described embodiment, two current sources, that is, the first current unit 21 and the second current unit 22, are provided as the current source. However, the number of the current source is not limited to two. It is also possible to provide three or more current source each having different current regulations, and add the constant currents output from those current sources at an arbitrary setting ratio. In such a case, it is possible to set a current regulation from a wide range including zero by having a current source configured to have a current regulation being substantially zero.

Furthermore, in the above-described embodiment, the current amplifying unit 24 is provided and it has polarity switching function, as well as the amplifying function, to obtain the constant current I3 by amplifying the constant current (I1+I2) after addition at an arbitrary setting ratio, by n-fold (or −n-fold). However, the current amplifying unit 24 is not essential. It is to be noted that it is advantageous for the following signal processing to provide the current amplifying unit 24 for amplifying and the polarity switching function of the current amplifying unit 24 widens the application field of the constant-current source circuit.

Up to this point, the present invention has been described according to the preferred embodiments. However, the constant-current source circuit of the present invention is not limited to only the configuration of the above-described embodiments and the constant-current source circuit with various changes and modifications made from the configuration of the above-described embodiments are included within the scope of the present invention.

In addition, the intermediate-frequency (IF) gain control IC on which the constant-current source circuit (constant-current generating unit 13) according to the present embodiment is used as an intermediate-frequency (IF) gait control IC at an RF (radio frequency) front-end portion in a digital cellular terminal (portable telephone) of CDMA (Code Division Multiple Access) system, for example. FIG. 7 is a block diagram showing a structural example of the RF front-end portion in the digital cellular terminal of the CDMA system.

In FIG. 7, a received wave received at an antenna 31 passes through a duplexer 32 which is commonly used for received waves and transmitted waves, and is supplied to a mixer 34 after a predetermined signal processing at a high-frequency (HF) signal processing circuit 33. At the mixer 34, the received wave is mixed with a local oscillating frequency from a local oscillator to be an intermediate frequency (IF). After a signal processing such as a quadrature modulation or the like at an intermediate-frequency (IF) gain control circuit 36, the received wave is converted into a digital format at an A/D converter 37 to be supplied to a baseband IC 38.

On the other hand, on the transmission side, the digital IF signal supplied from the former step, i.e., the baseband IC 38, is converted into an analog format at a D/A converter. After a signal processing such as a quadrature modulation or the like at an intermediate-frequency (IF) gain control circuit 40, the digital IF signal, which is already converted into an analog signal, is supplied to a mixer 41 to be mixed with a local oscillating frequency from a local oscillator 42 so as to be an RF signal. The RF signal is supplied to the antenna 31 through the duplexer 32 after a predetermined signal processing at a high-frequency (HF) signal processing circuit 43, to be transmitted from the antenna as a radio wave.

In the RF front-end portion of the digital cellular terminal of the CDMA system having the above-described configuration, for example, the intermediate-frequency (IF) gain control IC on which the constant-current source circuit according to the embodiment described above is mounted is used as the intermediated-frequency (IF) gain control circuit 40 on the transmission side. At the RF front-end portion, since external circuits such as the A/D converter 37 and the D/A converter 39 require a constant current, the constant current generated at the constant-current source circuit in the intermediate-frequency (IF) gain control IC is supplied to these external circuits.

Incidentally since the intermediate-frequency (IF) gain control IC on which the constant-current source circuit according to the embodiment described above is mounted has, as is apparent from FIG. 1, a quadrature modulating unit, it is used as the intermediate-frequency (IF) gain control circuit 40 on the transmission side. It is of course allowable to use the intermediate-frequency (IF) gain control IC on which the constant-current source circuit according to the embodiment described above as the intermediate-frequency (IF) gain control circuit 36 on the reception side.

In this way, by configuring the RF front-end portion of the digital cellular terminal of the CDMA system with the intermediate-frequency gain control IC on which the constant-current source circuit according to the embodiment described above is employed, the constant-current source circuit of the present invention is mounted as an additional function of the intermediate-frequency gain control IC. In this case, peripheral circuits of the IC may utilize this additional function, leading to an increase of commercial value of the IC.

Additionally, in the case of the constant-current source circuit according to the embodiment described above, variation of the temperature characteristic can be arbitrarily set in accordance with the external circuits such as the resistors Rs1 and Rs2, the designer of the products such as mobile terminal devices need not to search for a constant-current source circuit having a temperature characteristic which meets the requirements for a new specification every time the specification changes, and thus, the workload for designing the product set can be reduced. In addition, since the constant-current source circuit according to the embodiment described above has the characteristic function as described above in a simple circuit structure, it is possible to have the intermediate-frequency gain control circuit in a minimum size. Accordingly, the present invention is suitably applied to the digital cellular terminals of the CDMA system, which demand for miniaturization and light weight design.

In this embodiment described above, the case where the present invention is applied to the digital cellular terminal of the CDMA system has been explained. However, the present invention is not limited to such a case and can be applied to over all mobile terminal devices.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

What is claimed is:

1. A constant-current source circuit, comprising:
a plurality of current sources each being configured to have a current configuration different from that of the other one;
output means for adding and outputting output currents of said plurality of current source; and
setting means for setting an additional ratio of said output currents at said output means.

2. The constant-current source circuit according to claim 1, wherein:
said plurality of current source includes a current source configured to have a current regulation to be substantially zero (0).

3. The constant-current source circuit according to claim 1, wherein;
said setting means is an external resistor which determines a current value of each output current of said plurality of current sources.

4. The constant-current source circuit according to claim 1, wherein:
said output means has a current amplifying unit which amplifies a current obtained by adding the output currents to output an amplified current.

5. The constant-current source circuit according to claim 4, wherein:
said current amplifying unit has a polarity switching function for switching polarity of a current in accordance with a control signal received from outside.

6. An intermediate-frequency gain control circuit on which a constant-current source circuit is mounted, wherein said constant-current source circuit comprises:
a plurality of current sources each being configured to have a current configuration different from that of the other one;
output means for adding and outputting output currents of said plurality of current source; and
setting means for setting an additional ratio of said output currents at said output means.

7. The intermediate-frequency gain control circuit according to claim 6, wherein:
said plurality of current source includes a current source configured to have a current regulation to be substantially zero (0).

8. The intermediate-frequency gain control circuit according to claim 6, wherein:
said setting means is an external resistor which determines a current value of each output current of said plurality of current sources.

9. The intermediate-frequency gain control circuit according to claim 6, wherein:
said output means has a current amplifying unit which amplifies a current obtained by adding the output currents to output an amplified current.

10. The intermediate-frequency gain control circuit according to claim 9, wherein:
said current amplifying unit has a polarity switching function for switching polarity of a current in accordance with a control signal received from outside.

11. A mobile terminal device having a front-end portion, wherein said front-end portion comprises an intermediate-frequency gain control circuit having employed a constant-current source circuit, comprising:
a plurality of current sources each being configured to have a current configuration different from that of the other one;
output means for adding and outputting output currents of said plurality of current source: and
setting means for setting an additional ratio of said output currents at said output means.

12. The mobile terminal device according to claim 11, wherein:
said plurality of current source includes a current source configured to have a current regulation to be substantially zero (0).

13. The mobile terminal device according to claim 11, wherein:
said setting means is an external resistor which determines a current value of each output current of said plurality of current sources.

14. The mobile terminal device according to claim 11, wherein:
said output means has a current amplifying unit which amplifies a current obtained by adding the output currents to output an amplified current.

15. The mobile terminal device according to claim 14, wherein:
said current amplifying unit has a polarity switching function for switching polarity of a current in accordance with a control signal received from outside.
